(19) United States
(12) Patent Application Publication
(10) Pub. No.: US 2024/0054212 A1
(43) Pub. Date: Feb. 15, 2024

(54) METHOD, SYSTEM AND APPARATUS FOR SECURITY MONITORING OF VEHICLE-MOUNTED SYSTEM

(71) Applicant: Black Sesame Technologies (Chongqing) Co., Ltd., Chongqing (CN)

(72) Inventors: YouDan Hu, Chengdu (CN); BinTong Wen, Chengdu (CN); Lin Li, Chengdu (CN)

(21) Appl. No.: 18/234,313

(22) Filed: Aug. 15, 2023

(30) Foreign Application Priority Data
Aug. 15, 2022 (CN) 202210974422.3

(51) Int. Cl. G06F 21/55

(52) U.S. Cl. CPC G06F 21/552; G06F 2221/034

(57) ABSTRACT

The present application provides a method, a system and an apparatus for security monitoring of a vehicle-mounted system, the vehicle-mounted system includes a plurality of levels of functions, and the method includes: receiving, by a first security monitoring module of a first level of the plurality of levels, first exception information send by a second security monitoring module of a second level, where the first level is an upper level of the second level; determining, by the first security monitoring module, whether the first exception information exceeds a processing range of the first security monitoring module; and sending, by the first security monitoring module, the first exception information to a third level when the first exception information exceeds the processing range of the first security monitoring module, and performing security processing on the first exception information by the third level, where the third level is an upper level of the first level. According to a technical solution of the present application, different processing are performed on different exceptions by different processing levels, thereby improving efficiency of processing the exception information by the vehicle-mounted system.

### TECHNICAL FIELD

The present application relates to the technical field of vehicle security, and in particular, to a method, a system and an apparatus for security monitoring of a vehicle-mounted system.

### BACKGROUND

In a running process of a vehicle-mounted system (such as an intelligent vehicle-mounted system), various exception situations may occur, that is, various exception information is generated, and some exceptions may even cause the vehicle-mounted system to be paralyzed. Therefore, when the vehicle-mounted system faces different exceptions, if a reasonable processing mechanism is lacked, serious accidents may be caused, and even inconspicuous exceptions may also be gradually evolved into non-controllable fatal exceptions through some complex operations.

Therefore, how to efficiently process different exception information to make the vehicle-mounted system operate stably and safely becomes a technical problem to be solved urgently.

### SUMMARY

In view of this, embodiments of the present application provide a method, a system, and an apparatus for security monitoring of a vehicle-mounted system, which may improve efficiency of processing exception information by the vehicle-mounted system.

According to a first aspect, the embodiments of the present application provide a method for security monitoring of a vehicle-mounted system, the vehicle-mounted system includes a plurality of levels of functions, and the method includes: receiving, by a first security monitoring module of a first level of the plurality of levels, first exception information sent by a second security monitoring module of a second level, where the first level is an upper level of the second level; determining, by the first security monitoring module, whether the first exception information exceeds a processing range of the first security monitoring module; and sending, by the first security monitoring module, the first exception information to a third level when the first exception information exceeds the processing range of the first security monitoring module, and performing security processing on the first exception information by the third level, wherein the third level is an upper level of the first level.

In some embodiments of the present application, the method further includes: performing security processing on the first exception information by the second security monitoring module when the first exception information does not exceed a processing range of the second security monitoring module; or performing security processing on the first exception information by the first security monitoring module when the first exception information does not exceed the processing range of the first security monitoring module.

In some embodiments of the present application, the method further includes: monitoring, by the first security monitoring module, a running state of the first level.

In some embodiments of the present application, the method further includes: monitoring, by the first security monitoring module, a running state of a function module included in the second level and a running state of the second security monitoring module, where, the first level includes a virtual machine monitor, the second level includes a plurality of operating systems, and the third level includes an ECU security island core.

In some embodiments of the present application, before the receiving, by a first security monitoring module of a first level of the plurality of levels, first exception information sent by a second security monitoring module of a second level, the method further includes: collecting, by a diagnostic module of the second level, second exception information of a function module on an operating system; sending, by the diagnostic module, the second exception information to the second security monitoring module; dividing, by the second security monitoring module, the second exception information into a corresponding security level; controlling the function module to restart according to the security level, or sending the second exception information to a processing module corresponding to the security level for security processing according to the security level, by the second security monitoring module, where the processing module includes the function module; and taking the second exception information as the first exception information when the second exception information exceeds a processing range of the processing module, and sending, by the second security monitoring module, the first exception information to the first security monitoring module.

According to a second aspect, the embodiments of the present application provide an apparatus for security monitoring of a vehicle-mounted system, the vehicle-mounted system includes a plurality of levels of functions, and the apparatus includes: a receiving module, configured to receive, by a first security monitoring module of a first level of the plurality of levels, first exception information sent by a second security monitoring module of a second level, where the first level is an upper level of the second level; a determining module, configured to determine, by the first security monitoring module, whether the first exception information exceeds a processing range of the first security monitoring module; and a first sending module, configured to send, by the first security monitoring module, the first exception information to a third level when the first exception information exceeds the processing range of the first security monitoring module, and perform security processing on the first exception information by the third level, where the third level is an upper level of the first level.

According to a third aspect, the embodiments of the present application provide an electronic device, which includes: a processor; and a memory configured to store instructions executable by the processor, where the processor is configured to execute the method for security monitoring of a vehicle-mounted system according to the first aspect.

According to a fourth aspect, the embodiments of the present application provide a vehicle, which includes the apparatus for security monitoring of a vehicle-mounted system according to the second aspect, or the electronic device according to the third aspect.

According to a fifth aspect, the embodiments of the present application provide a computer-readable storage medium, the storage medium stores a computer program, and the computer program is configured to execute the method for security monitoring of a vehicle-mounted system according to the first aspect.

According to a sixth aspect, the embodiments of the present application provide a system for security monitoring of a vehicle-mounted system, which includes: an operating system level, configured to collect exception information, and send the exception information to a first security monitoring module of a virtual machine monitor when the exception information exceeds a processing range of a second security monitoring module in an operating system, where the virtual machine monitor is an tipper level of the operating system level; the virtual machine monitor, where the first security monitoring module of the virtual machine monitor is configured to receive the exception information sent by the second security monitoring module, determining whether the exception information exceeds a processing range of the first security monitoring module, and send the exception information to an ECU security island core when the exception information exceeds the processing range of the first security monitoring module, where the ECU security island core is an upper level of the virtual machine monitor; the ECU security island core, configured to receive the exception information, determine whether the exception information exceeds a processing range of the ECU security island core, and send the exception information to a microcontroller unit when the exception information exceeds the processing range of the ECU security island core, where the microcontroller unit is an upper level of the ECU security island core; and the microcontroller unit, configured to perform security processing on the exception information.

According to a method, a system and an apparatus for security monitoring of a vehicle-mounted system provided by the embodiments of the present application, a first security monitoring module is provided at a first level, and a second security monitoring module is provided at a second level. Exception information information exceeding a processing range of the second security monitoring module is sent to the first security monitoring module, and then the exception information is sent to a third level for security processing when the exception information exceeds a processing range of the first security monitoring module, so that the exception information may be reasonably managed, different levels of processing are performed for different exception information, stable operation of the vehicle-mounted system is ensured, a problem of processing flow redundancy during function security processing is avoided, and processing efficiency of exception information is improved. Meanwhile, the security monitoring module is arranged in different levels, so that an impact of the exception information on the operation of the vehicle-mounted system may be prevented in time in a depth defense mode.

### BRIEF DESCRIPTION OF THE DRAWINGS

FIG. 1 is a schematic diagram of a software architecture of a vehicle-mounted system according to an exemplary embodiment of the present application.

FIG. 2 is a schematic flowchart of a method for security monitoring of a vehicle-mounted system according to an exemplary embodiment of the present application.

FIG. 3 is a schematic diagram of a system for security monitoring of a vehicle-mounted system according to an exemplary embodiment of the present application.

FIG. 4 is a schematic flowchart of a method for security monitoring of a vehicle-mounted system according to another exemplary embodiment of the present application.

FIG. 5 is a schematic flowchart of a method for security monitoring of a vehicle-mounted system according to still another exemplary embodiment of the present application.

FIG. 6 is a schematic diagram of a system for security monitoring of a vehicle-mounted system according to another exemplary embodiment of the present application.

FIG. 7 is a schematic structural diagram of an apparatus for security monitoring of a vehicle-mounted system according to an exemplary embodiment of the present application.

FIG. 8 is a block diagram of an electronic device for security monitoring according to an exemplary embodiment of the present application.

FIG. 9 is a block diagram of a vehicle according to an exemplary embodiment of the present application.

FIG. 10 is a block diagram of a vehicle according to another exemplary embodiment of the present application.

### DETAILED DESCRIPTIONS OF THE EMBODIMENTS

Technical solutions in the embodiments of the present application are clearly and completely described below with reference to the accompanying drawings in the embodiments of the present application. Apparently, the described embodiments are a part of the embodiments of the present application, rather than all the embodiments. Based on the embodiments of the present application, all other embodiments obtained by those of ordinary skill in the art without creative work fall within the protection scope of the present application.

Application Overview

In order to realize a security detection of an intelligent vehicle-mounted system, security processing may be performed on a detected fault by a unified fault management module. For example, an operation state of a function of each level of a vehicle may be monitored, and a fault notification is reported to a fault management module when a fault occurs. The fault management module confirms a fault type according to the fault notification, performs corresponding preprocessing, and performs corresponding function security processing after the preprocessing is finished.

However, by means of the foregoing function security processing and preprocessing, when a real-time requirement of the fault notification (or exception information) is relatively high, a situation of untimely response may occur, and division of labor between the two functions (the function security processing and pre-processing) may not be clearly distinguished, that is, the preprocessing can solve some simple faults, so there is no need for the fault management module to perform function security processing, resulting in functional redundancy and inability to efficiently and stably process the faults. Moreover, the fault management module lacks a self-checking mechanism, that is, when the fault management module itself has an error, an operation fault system of the whole vehicle-mounted system may be disordered, so that a safe and stable operation environment may not be provided.

For the above problems, the embodiments of the present application provide a method for security monitoring and a system for security monitoring, and various non-limiting embodiments of the present disclosure are specifically described below with reference to the accompanying drawings.

For ease of understanding, a concept of the hypervisor involved in the embodiments of the present application is briefly introduced.

Hypervisor, also referred to as a Virtual Machine Monitor (VMM), serves as a core of virtualization technology to establish and execute software, firmware, or hardware of virtual machines. Through virtualization technology, a plurality of computer systems having complete hardware configurations and running in a fully isolated environment may be simulated on a physical server, that is, virtual machines. A virtual machine monitor is an intermediate software layer running between a base physical server and an operating system which may allow multiple operating systems and applications to share hardware. The virtual machine monitor may fully take over hardware resources such as a CPU, a memory, a hard disk and a network card of a physical server, abstract the hardware resources into a logic resource pool, and allocate the logic resource pool to each virtual machine according to demand, so that each virtual machine can independently use its own hardware resources such as a virtual CPU, a memory, a hard disk and a network card. The virtual machine monitor can directly run on a physical hardware, directly manage all hardware resources downwards, and install operating systems and deploy applications on virtual machines by creating a plurality of virtual machines upwards.

Exemplary System

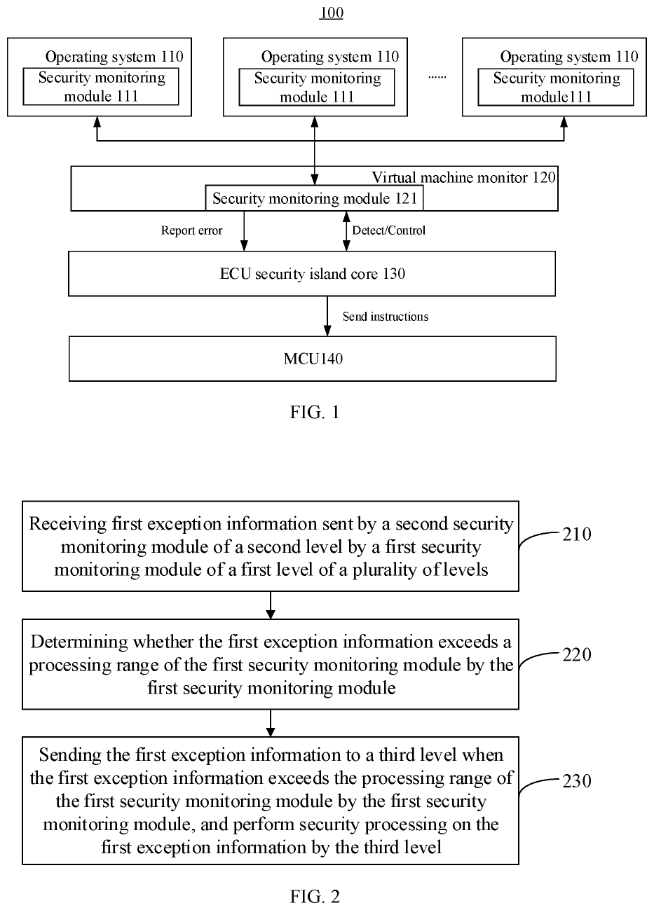

FIG. 1 is a schematic diagram of an architecture of a vehicle-mounted system 100 according to an exemplary embodiment of the present application.

The vehicle-mounted system may include a plurality of levels of functions. As shown in FIG. 1, a Microcontroller Unit (MCU) 140, an Electronic Control Unit (ECU) security island core 130, a virtual machine monitor 120, and a plurality of operating systems 110 are sequentially arranged from bottom to top.

Each operating system 110 may include a security monitoring module 111 (for example, a second security monitoring module described in the following embodiments), configured to monitor a running state of each operating system, collect exception information occurring in each operating system, and the like, where the running state may include starting, running, or exception pausing. The security monitoring module 111 may also process a portion of exceptions occurring in the operating system, and report to the virtual monitor 120 for an exception that does not belong to a processing range of the security monitoring module 111.

The virtual machine monitor 120 may include a security monitoring module 121 (for example, a first security monitoring module described in the following embodiments), configured to receive exception information reported by the security monitoring module 111 of the operating system 110. The security monitoring module 121 is further configured to collect exception information and the like generated in the virtual machine monitor 120. For the exception information reported by the security monitoring module 111 and the exception information generated in the virtual machine monitor 120, if the exception information belongs to a processing range of the security monitoring module 121, the security monitoring module 121 may processe the exception information locally, and report to the ECU security island core 130 for the exception information that does not belong to the processing range of the security monitoring module 121.

The ECU security island core 130, that is the ECU security island core system (for example, R5 Safety island) may be configured to supervise security of the ECU security island core, and receive the exception information reported by the security monitoring module 121. The ECLU security island core 130 may also process a portion of exceptions reported by the security monitoring module 121 and a portion of exceptions generated in the ECU security island core 130, and report to the MCU 140 for an exception that does not belong to a processing range of the ECU security island core 130.

The MCU 140 may be configured to supervise security of the MCU, receive an exception information reported by the ECU security island core 130, and perform security processing on the exception information reported by the ECU security island core 130.

It should be noted that when the security monitoring module of each level receives an exception information reported by the security monitoring module of a lower level, the security monitoring module of the level first determines whether itself has an ability to process an exception situation indicated by the exception information, if it does, it processes the exception situation, and if it does not, it reports the exception information to an upper level. In other words, since the exception information exceeds a processing range of the security monitoring module, that is, the security monitoring module does not have the ability to process the exception information, the exception information needs to be processed by a security monitoring module of the upper level, so as to facilitate recovery from an exception.

The exception information may include an exception error code, different exception error codes indicating different exception information may be generated according to the different exception information, and the exception error code may further include a level of generating an exception (or fault) or a function module running in the operating system. For example, the exception error code may be used to indicate which function module (such as an application program) in the operating system generates an exception or a fault.

Exemplary Method

FIG. 2 is a schematic flowchart of a method for security monitoring of a vehicle-mounted system according to an exemplary embodiment of the present application. The method of FIG. 2 is performed by a vehicle-mounted device, and specifically, the method may be performed by a system for security monitoring running on the vehicle-mounted device. As shown in FIG. 2, the method for security monitoring includes the following content.

It should be noted that the system for security monitoring according to an embodiment of the present application may run in a vehicle-mounted system, and is configured to perform operations such as security monitoring and exception (or fault) recovery on the vehicle-mounted system. The security monitoring system may include security monitoring modules based on a plurality of levels in a vehicle-mounted system, an ECU security island core (for example, R5 Safety island) and an MCU.

In an embodiment, the vehicle-mounted system may include a plurality of levels of functions.

210: receiving first exception information sent by a second security monitoring module of a second level by a first security monitoring module of a first level of a plurality of levels.

In an embodiment, the first level is an ripper level of the second level.

Specifically, the vehicle-mounted system may include the first level and the second level, and the first level is the upper level of the second level, that is, the first level is a superior of the second level. The first level may include a virtual machine monitor (that is, the Hypervisor) or the ECU security island core, correspondingly, the second level may include a plurality of operating systems or a virtual machine monitor, and the first level and the second level are not specifically limited in the embodiments of the present application. For example, when the first level includes a virtual machine monitor, the second level includes a plurality of operating systems; and when the first level includes an ECU security island core, the second level includes a virtual machine monitor.

In an embodiment, the second level may include a plurality of operating systems. Each operating system may include the second security monitoring module, configured to monitor a running state of each operating system, collect the first exception information appearing in each operating system, and the like. The running state may include starting, running, or exception pausing. The first level may include the virtual machine monitor, the virtual machine monitor may include the first security monitoring module, and the first security monitoring module may be configured to receive the first exception information reported by the second security monitoring module.

It should be noted that the second security monitoring module reports the first exception information because the first exception information exceeds a processing range of the second security monitoring module, that is, the second security monitoring module does not have the ability to process the first exception information, and the first exception information needs to be processed by the first security monitoring module of the upper level, so as to facilitate recovery from an exception.

220: determining whether the first exception information exceeds a processing range of the first security monitoring module by the first security monitoring module.

Specifically, the first security monitoring module may judge the first exception information, and determine whether the first exception information exceeds the processing range of the first security monitoring module.

In an embodiment, when detecting that the first exception information exceeds the processing range of the first security monitoring module, the first security monitoring module reports the first exception information to a third level, where the third level is an upper level of the first level. Alternatively, when the first security monitoring module detects that the first exception information does not exceed the processing range of the first security monitoring module, the first security monitoring module may perform security processing on the first exception information to facilitate recovery from an exception.

230: sending the first exception information to a third level when the first exception information exceeds the processing range of the first security monitoring module by the first security monitoring module, and perform security processing on the first exception information by the third level.

In an embodiment, the third level is the upper level of the first level. Specifically, the vehicle-mounted system may further include the third level, and the third level is the upper level of the first level, that is, the third level is a superior of the first level. The third level may include the ECU security island core or the MCU, and the third level is not specifically limited in the embodiments of the present application. For example, when the first level includes the virtual machine monitor, the third level includes the ECU security island core; and when the first level includes the ECU security island core, the third level includes the MC.

In an embodiment, when the first exception information exceeds the processing range of the first security monitoring module, that is, when the first security monitoring module cannot handle the first exception information, the first security monitoring module may report the first exception information to the third level, so that the third level may handle the first exception information and realize recovery form an exception.

In another embodiment, the vehicle-mounted system may further include a fourth level. The third level may judge the first exception information when receiving the first exception information reported by the first security monitoring module; and when the first exception information exceeds a processing range of the third level, the third level may report the first exception information to the fourth level, and the fourth level may perform security processing on the first exception information to realize recovery from an exception.

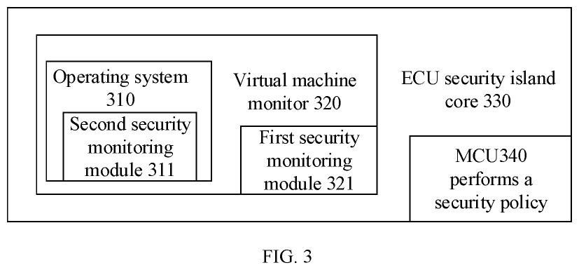

In an embodiment, the first level may include the virtual machine monitor, the third level may include the ECU security island core, and the virtual machine monitor may include the first security monitoring module. For example, referring to FIG. 3, the virtual machine monitor 320 includes the first security monitoring module 321, when it is detected that the first exception information exceeds the processing range of the first security monitoring module 321, the first security monitoring module 321 of the virtual machine monitor 320 reports the first exception information to the EC U security island core 330, so that the EC U security island core 330 may handle the first exception information.

In another embodiment, the first level may include the ECU security island core, and the third level may include the MCU. For example, the ECU security island core 330 and the MCU 340 are shown in FIG. 3, and the ECU security island core may be an ECU core provided for security monitoring. When it is detected that the first exception information exceeds the processing range of the first security monitoring module, the ECU security island core may report the first exception information to the MCU, and the MCU may perform a security policy to handle the first exception information and realize recovery from an exception.

It should be noted that the embodiments of the present application may be understood to be implemented by implementing a multi-layer function security control policy, that is, by establishing a function security design of depth defense. For example, in a case where the first level includes the virtual machine monitor (that is, Hypervisor), the second level includes a plurality of operating systems, and the third level includes the ECU security island core (for example, R5 Safety island), the first security monitoring module of the hypervisor may control an operation of the second security monitoring module in the operating system, so that the second security monitoring module has two layers of function security protection.

It should also be noted that when an exception occurs in a specific service or application installed on a specific operating system, and the exception needs to be actively reported to the first security monitoring module by the second security monitoring module in the operating system, firstly, the second security monitoring module of the operating system collects, analyzes and processes the exception occurred in the service, so as to obtain the first exception information, and performs function security processing on the service monitored by the second security monitoring module. However, the first exception information that cannot be handled by the second security monitoring module itself, maybe reported to the superior (Hypervisor) of the second security monitoring module. Secondly, when the first security monitoring module of the hypervisor receives the first exception information actively reported by a subordinate, the first security monitoring module may perform exception processing. Finally, if the exception is very serious, the first security monitoring module of the hypervisor cannot make a decision, the first exception information should continue to be reported to the ECU security island core (for example, R5 Safety island) for processing. R5 Safety island is a function security system of the ECU core level, which has a higher power level than the hypervisor. According to the level of protection layer by layer, damage of the exception may be reduced as much as possible.

Therefore, according to the embodiments of the present application, the first security monitoring module is provided at the first level, the second security monitoring module is provided at the second level. The exception information exceeding the processing range of the second security monitoring module is sent to the first security monitoring module, and then the exception information is sent to the third level for security processing when the exception information exceeds the processing range of the first security monitoring module, so that the exception information may be reasonably managed, different levels of processing are performed for different exception information, the stable operation of the vehicle-mounted system is ensured, the problem of processing flow redundancy during function security processing is avoided, and the processing efficiency of the exception information is improved. Meanwhile, the security monitoring module is arranged in different levels, so that the impact of the exception information on the operation of the vehicle-mounted system may be prevented in time in a depth defense mode.

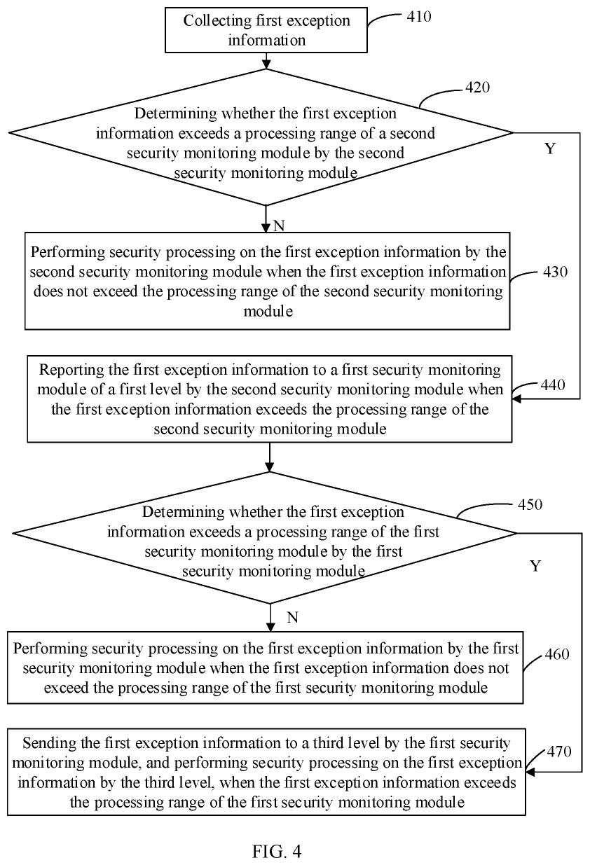

FIG. 4 is a schematic flowchart of a method for security monitoring of a vehicle-mounted system according to another exemplary embodiment of the present application. The embodiment of FIG. 4 is an example of the embodiment of FIG. 2, contents that are the same between the two embodiments are not repeated here, and differences between the two embodiments are described here. As shown in FIG. 4, the method for security monitoring includes the following contents.

410: collecting first exception information.

420: determining whether the first exception information exceeds a processing range of a second security monitoring module by the second security monitoring module.

430: performing security processing on the first exception information by the second security monitoring module when the first exception information does not exceed the processing range of the second security monitoring module.

Specifically, when the second security monitoring module detects that the first exception information does not exceed the processing range of the second security monitoring module, the second security monitoring module may perform security processing on the first exception information to realize recovery from an exception.

440: reporting the first exception information to a first security monitoring module of a first level by the second security monitoring module when the first exception information exceeds the processing range of the second security monitoring module.

450: determining whether the first exception information exceeds a processing range of the first security monitoring module by the first security monitoring module.

460: performing security processing on the first exception information by the first security monitoring module when the first exception information does not exceed the processing range of the first security monitoring module.

Specifically, when detecting that the first exception information does not exceed the processing range of the first security monitoring module, the first security monitoring module may perform security processing on the first exception information. It should be noted that, when the first exception information can be handled by the first security monitoring module, the first security monitoring module does not need to report the first exception information and may process the first exception information by itself.

470: sending the first exception information to a third level by the first security monitoring module, and performing security processing on the first exception information by the third level, when the first exception information exceeds the processing range of the first security monitoring module.

Therefore, according to the embodiment of the present application, an exception that can be processed by the first security monitoring module may be processed by itself without reporting the exception to the upper level, thereby avoiding the problem of processing flow redundancy during exception information processing, and improving the processing efficiency of the exception information.

In an embodiment of the present application, the method further includes: monitoring a running state of the first level by the first security monitoring module.

Specifically, in addition to receiving the first exception information reported by the second security monitoring module of the second level, the first security monitoring module may further perform security monitoring on the first level.

In an embodiment, the security monitoring module may monitor the running state of the first level by the first security monitoring module, where the running state includes starting, running, or exception pausing.

In an embodiment, the first security monitoring module may be a security monitoring module included in the virtual machine monitor. It should be noted that, for a hypervisor, a security monitoring module (such as a first security monitoring module) is also required to protect the hypervisor, monitor an exception occurring in the hypervisor, and perform analysis processing.

Therefore, in this embodiment of the present application, the first security monitoring module is provided to detect the running state of the first level, so that the exception occurring in the first level may be monitored by the first security monitoring module, so as to ensure a safe operation of the first level.

In an embodiment of the present application, the method further includes: monitoring, by the first security monitoring module, a running state of a function module included in the second level and a running state of the second security monitoring module.

Specifically, the first security monitoring module of the first level may monitor the running state of the function module included in the second level (that is the lower level of the first level), and the running state of the second security monitoring module included in the second level. The running state may include starting, running, or exception pausing. The function module may be an application program or a service running on the second level, for example, the function module is an application program running on an operating system.

For example, a heartbeat mechanism may be used for a monitoring mode of the running state of the second security monitoring module, and the monitoring mode is not specifically limited in the embodiments of the present application. The first security monitoring module may periodically send a heartbeat monitoring message to the second security monitoring module, and if the second security monitoring module returns a response message according to the heartbeat monitoring message, it is proved that the second security monitoring module is running normally; otherwise, the second security monitoring module is exceptionally paused.

In an embodiment, a monitoring mode of a running state of an application program in the second level may be periodically monitoring, or maybe a heartbeat mechanism, which is not specifically limited in the embodiments of the present application. For example, the first security monitoring module monitors the running state of the application program in real time.

It should be noted that the first level may include the hypervisor, and the second level includes a plurality of operating systems. In this embodiment of the present application, in addition to ensuring security by actively reporting the first exception information level by level when an exception occurs in the operating system, this embodiment may also track and manage an application service on the operating system by a manner of reversely monitoring the operating system. For the application service on the operating system, the second security monitoring module needs to track and manage a life cycle of a service process, for example, when a service or an application process crashes accidentally, the security monitoring module may detect problems in time, focus and analyze an exception, and finally make decisions and processing on the exception. Similarly, the first security monitoring module of the hypervisor may track and monitor the running state of a plurality of operating systems and the running state of the second security monitoring modules inside the operating systems. In addition, the ECU security island core (for example, R5 Safety island) as the security monitoring module with the highest power level, may also track and monitor the level including the hypervisor to grasp the running state thereof.

It should also be noted that, in the function security design using defense in depth, there are both active reporting and level by level protection for an exception by security monitoring modules, and reverse function security tracking and monitoring for each exception level by level.

Therefore, in this embodiment of present application, the security monitoring module (such as the second security monitoring module) is monitored, so that the security monitoring module (for example, the first security monitoring module) may monitor, in real time, whether the security monitoring module (such as the second security monitoring module) of the lower level is unable to respond or in other exception situations, and may process the exception in time. That is to say, the security monitoring module of the lower level itslf is also guaranteed by the security monitoring module of the upper level, so that a situation that the second security monitoring module cannot process other exceptions due to a failure of the second security monitoring module may be avoided, and a problem that the second security monitoring module cannot operate normally for a long time, resulting in a crash of the whole vehicle-mounted system may also be avoided. Meanwhile, the security monitoring module of the upper level further monitors the lower level to obtain the running state of the lower level, thereby providing a guarantee for the normal operation of the lower level.

In an embodiment of the present application, the first level includes the virtual machine monitor, the second level includes a plurality of operating systems, and the third level includes the ECU security island core.

Specifically, in a case where the first level includes the virtual machine monitor (that is, Hypervisor), the second level may include a plurality of operating systems, and the third level may include the ECU security island core.

As shown in FIG. 1, a vehicle-mounted system may include a first level, a second level, a third level, and a fourth level from a lower level to an upper level. The second level may include a plurality of operating systems 110, each of which may include a security monitoring module 111 (that is, a second security monitoring module). The first level may include a virtual machine monitor 120, which may include a security monitoring module 121 (that is, a first security monitoring module). The third level may include an ECU security island core 130, and the fourth level may include an MCU 140.

With continued reference to FIG. 1, first, in each operating system 110, the second security monitoring module is required to monitor and make decisions on the current operating system 110, which is a basic operation that needs to be completed by the second security monitoring module. That is, when there are a plurality of operating systems 110, there should be a second security monitoring module in each operating system 110. From a longitudinal perspective of a hierarchical relationship of the security monitoring system, a next layer of the plurality of operating systems 110 is a hypervisor 120, and the hypervisor is an intermediate layer running between the base physical server and the operating system, which implements a function of multiple systems sharing physical resources, while it also has a resource allocation right to the upper operating system. There is also a first security monitoring module in the hypervisor 120, and the first security monitoring module may not only monitor the hypervisor, but also control and manage the second security monitoring modules in the plurality of operating systems 110 on the upper layer.

Furthermore, the first security monitoring module in the virtual machine monitor also has a right to directly monitor a state of the operating system because the virtual machine monitor owns the resource allocation right, so that for a layer where the operating systems are located, it is not only guaranteed by the second security monitoring modules of the operating systems, but also guaranteed by the first security monitoring module of a higher level, which is undoubtedly a double insurance.

In another embodiment, the first level includes an ECU security island core, the second level includes a virtual machine monitor, and the third level includes a microcontroller unit.

It should be noted that, in this embodiment of the present application, a function security is designed with reference to hierarchical differentiation of an Advanced RISC Machine (ARM) processor architecture. Exception levels (EL) includes EL 0, EL 1, EL 2, and EL 3. EL 0 includes a plurality of application programs, and EL 1 includes a plurality of operating systems, that is, maybe equivalent to the second level in the embodiments of the present application. EL 2 includes a hypervisor, and EL 3 includes an ARM Trusted Firmware (ATF)/PSCI. In the embodiments of the present application, a security monitoring module may be added to the hypervisor of the EL 2 layer.

It should also be noted that the embodiment of the present application, by adding the security monitoring module (such as the first security monitoring module) to a hypervisor, includes the following advantages: 1) the hypervisor is used as a decision layer of the entire ECU Security island core group, and may sent a single-core control instruction to the EL 3 layer to realize its own control for the core; 2) the hypervisor may obtain the running state of the operating system in the EL 1, and the security monitoring module in the hypervisor may monitor each operating system, in the EL 1 to obtain the running state of each operating system, in addition, the security monitoring module may collect information about internal function security of the operating system and perform security management on the plurality of operating systems; and 3) as each operating system in the EL 1 requires a security monitoring module (for example, a second security monitoring module), for the hypervisor, a security monitoring module is also required to guarantee itself, monitor the exception that occurs within the hypervisor, and perform analysis and processing.

Therefore, in this embodiment of the present application, by setting the virtual machine monitor, a function of resource sharing for a plurality of operating systems is realized, and meanwhile, the virtual machine monitor may also perform resource allocation on the lower level operating system. Meanwhile, the security monitoring module is arranged on the virtual machine monitor, so that the security monitoring module may not only monitor the virtual machine monitor, but also control and manage the security monitoring module in the plurality of operating systems.

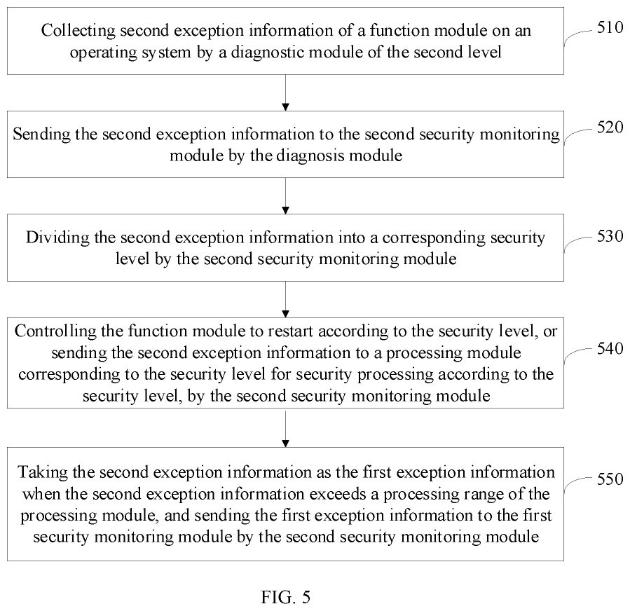

FIG. 5 is a schematic flowchart of a method for security monitoring of a vehicle-mounted system according to still another exemplary embodiment of the present application. FIG. 5 illustrates steps performed before step 210 in the embodiment of FIG. 2. As shown in FIG. 5, the method for security monitoring includes the following content.

510: collecting second exception information of a function module on an operating system by a diagnostic module of the second level.

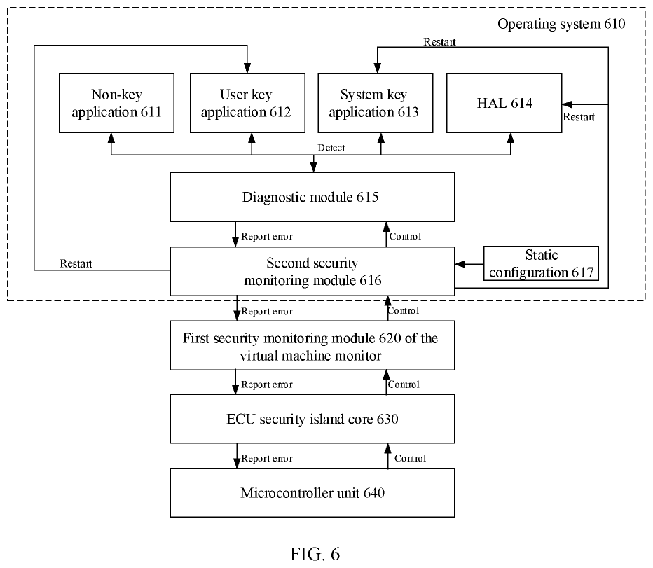

Specifically, referring to FIG. 6, an operating system in a second level may include a diagnostic module 615, which may also be referred to as a diagnostic service. The diagnostic module 615 is configured to collect exception information (that is, the second exception information) generated by the function module running on the operating system. The function module may include a non-key application 611, a user key application 612, a system key application 613, and a Hardware Abstraction Layer (HAL) 614.

The non-key application may refer to an application, such as an audio player, having a minor impact on an operation of the vehicle-mounted system. The user key application may refer to an application having a specific impact on the operation of the vehicle-mounted system, for example, a positioning apparatus, and an apparatus for acquiring a vehicle speed. The system key application may refer to an underlying application that is invisible to a user. It should be noted that the non-key application and the key application may be set by the user flexibly according to an actual situation, which is not specifically limited in the embodiments of the present application.

520: sending the second exception information to the second security monitoring module by the diagnosis module.

Specifically, referring to FIG. 6, the diagnostic module 615 may preliminarily filter the collected second exception information, delete second exception information that does not need to be processed, and send second exception information that needs to be recovered to the second security monitoring module 616 of the operating system 610. The second exception information is the same as the first exception information, the second exception information may include an exception error code, different exception error codes indicating different exception information may be generated according to the different exception information, and the exception error code may further include a function module running in the operating system for generating an exception (or fault). For example, the exception error code may be used to indicate which function module (such as an application program) in the operating system generates an exception or a fault.

For example, the audio player (that is, the non-key application) does not find a file to be played in a playing process, and at this time, the audio player may generate a second exception information. An exception error code included in the second exception information is used to indicate that the audio player does not find the file to be played, and the exception error code may indicate that the second exception information is generated by the non-key application.

It should be noted that the second security monitoring module in the operating system may be understood as a security service in the operating system. The security service in the operating system has ability to collect an exception state of the operating system and has a right to control and make decisions for all running modules. The collection of exception situations is divided into the following two manners, that is, a manner of process detection and a manner of diagnosis service actively reporting an error event.

It should also be noted that the process detection is mainly to maintain a static system key process table and a user configurable key process table for the security service. The static system key process table is preset by the system and read only by default. The user configurable key process table may support a user-defined process addition. Once the key process exits exceptionally, the security service may issue a notification to collect a running state of the process, and completes the processing of an error situation according to configuration. The diagnostic service report mainly includes: a diagnostic module (or diagnostic service) may collect all exception error events in the operating system, and send the exception error events to the second security monitoring module after preliminary filtering. After the second security monitoring module (or the security service) receives an internal error code, the security service may complete the processing of an error situation according to a preset decision scheme.

530: dividing the second exception information into a corresponding security level by the second security monitoring module.

Specifically, referring to FIG. 6, the second security monitoring module 616 may use a preset static configuration table 617 to divide the second exception information into a corresponding security level according to a function module, and the function module generates an exception and is indicated by an exception error code in the second exception information. The static configuration table includes security levels respectively corresponding to different function modules.

For example, the security level of the non-key application is 0; the security levels of the use key application, the system key application, and the HAL are 1; the security level of the diagnosis module is 2; and the security level of the second security monitoring module is 3. In addition, when the second level includes a plurality of operating systems, the security level of the first security monitoring module (for example, the first security monitoring module 620 of the virtual machine monitor shown in FIG. 6) of the first level is 4; the security level of the third level (that is, the ECU security island core 630 shown in FIG. 6) is 5; and the security level of the fourth level (that is, the microcontroller unit 640 shown in FIG. 6, for example, a single chip microcomputer TC397) is 6.

It should be noted that in order to ensure that all exceptions (or faults) can be monitored and processed at different levels, exceptions should be distinguished, and for a specified application program or service, there are four types of exceptions, that is, an internal error, a fatal error, no response and crash. The internal error and fatal error are monitored by the application program or service itself. No response and crash fauls are monitored by a higher level. Therefore, in this embodiment of the present application, the exception information in the vehicle-mounted system is divided into 7 security levels of 0-6.

540: controlling the function module to restart according to the security level, or sending the second exception information to a processing module corresponding to the security level for security processing according to the security level, by the second security monitoring module.

In an embodiment, the processing module may include a function module.

Specifically, the second security monitoring module may control the function module to restart according to the security level, and the function module may be a user key application, a system key application, or an HAL Alternatively, the second security monitoring module may send the second exception information to the processing module corresponding to the security level according to the security level for security processing. The processing module may include a function module, and the function module may be a non-key application.

In an embodiment, when the second security monitoring module determines that the security level corresponding to the second exception information is 1, and the second exception information may be recovered by restarting an application that generates the second exception information, the second security monitoring module may realize recovery form an exception by restarting the application corresponding to the second exception information. Alternatively, when the second security monitoring module determines that the security level corresponding to the second exception information is 1 and the user key application generating the second exception information may handle the second exception information itself, the second security monitoring module may send the second exception information to the user key application.

In another embodiment, when the second security monitoring module determines that the security level corresponding to the second exception information is 0 and the non-key application generating the second exception information may handle the second exception information itself, the second security monitoring module may send the second exception information to the non-key application.

550: taking the second exception information as the first exception information when the second exception information exceeds a processing range of the processing module, and sending the first exception information to the first security monitoring module by the second security monitoring module.

Specifically, when the second security monitoring module determines that the second exception information exceeds the processing range of the second security monitoring module, the second security monitoring module may take the second exception information as the first exception information. Then, the second security monitoring module may send the first exception information to the first security monitoring module of the first level, and the first security monitoring module handles the first exception information. The first level is an upper level of the second level.

It should be noted that the diagnostic module may collect events (such as exception information) with a security level of 1 and check them periodically. The exceptions found by the diagnosis module may be reported to the second security monitoring module with the security level of 3, and the second security monitoring module may process these exceptions. The second security monitoring module may also monitor all exceptions (or faults) having a security level of 1 and a security level of 2, and periodically check a diagnostic module having a security level of 2. Similarly, the second security monitoring module may send second exception information (such as a fatal error event) that cannot be handled by the second security monitoring module to a first security monitoring module, on a hypervisor, with a security level of 4, and second exception information (such as a fatal error event) that cannot be handled by the first security monitoring module may be sent to an ECU security island core (that is, an R5 core function security system) with a security level of 5. The R5 core may handle the second exception information and decide whether to restart the A55 core (where the hypervisor and the plurality of operating systems are located on the A55 core). The uppermost layer is an MCU, which may control the entire single chip microcomputer.

It should also be noted that the modules included in a plurality of levels are also classified, there is no situation where a plurality of exceptions occur at the same time and cannot be processed in time. Each level of security monitoring modules has its processing range, for the exceptions that exceed the processing range, may be handled by a higher-level security monitoring module.

Therefore, according to the embodiment of the present application, the exception information is distinguished, and the corresponding security level is divided, so that the embodiment of the present application may orderly perform different processing for different exceptions by different security monitoring modules, division of labor is clear, and processing efficiency of exceptions is improved.

Exemplary Apparatus

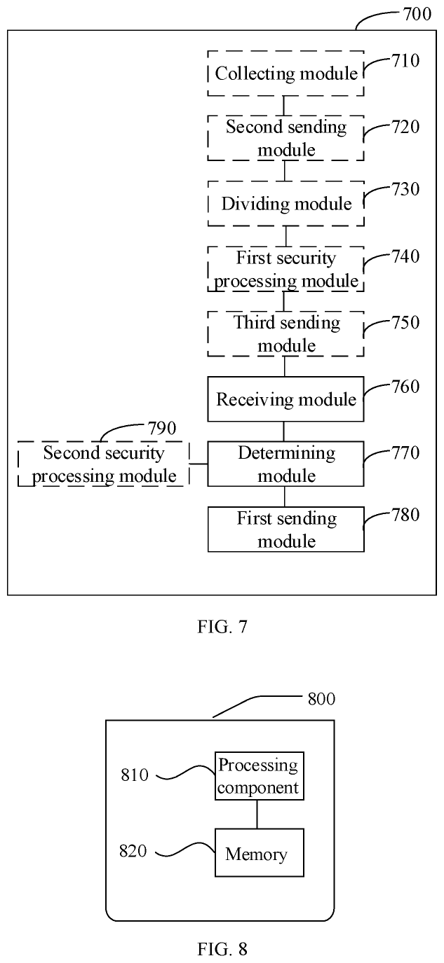

FIG. 7 is a schematic structural diagram of an apparatus 700 for security monitoring of a vehicle-mounted system according to an exemplary embodiment of the present application. As shown in FIG. 7, the apparatus 700 for security monitoring includes a collecting module 710, a second sending module 720, a dividing module 730, a first security processing module 740, a third sending module 750, a receiving module 760, a determining module 770, a first sending module 780, and a second security processing module 790.

The receiving module 760 is configured to receive, by a first security monitoring module of a first level of the plurality of levels, first exception information sent by a second security monitoring module of a second level, where the first level is an upper level of the second level; the determining module 770 is configured to determine, by the first security monitoring module, whether the first exception information exceeds a processing range of the first security monitoring module; the first sending module 780 is configured to send, by the first security monitoring module, the first exception information to a third level when the first exception information exceeds the processing range of the first security monitoring module, and perform security processing on the first exception information by the third level, where the third level is an upper level of the first level.

According to the apparatus for security monitoring of a vehicle-mounted system provided by the embodiments of the present application, the first security monitoring module is provided at the first level, the second security monitoring module is provided at the second level. The exception information exceeding the processing range of the second security monitoring module is sent to the first security monitoring module, and then the exception information is sent to the third level for security processing when the exception information exceeds the processing range of the first security monitoring module, so that the exception information may be reasonably managed, different levels of processing are performed for different exception information, the stable operation of the vehicle-mounted system is ensured, the problem of processing flow redundancy during function security processing is avoided, and the processing efficiency of the exception information is improved. Meanwhile, the security monitoring module is arranged in different levels, so that the impact of the exception information on the operation of the vehicle-mounted system may be prevented in time in a depth defense mode.

According to an embodiment of the present application, the second security processing module 790 is configured to perform security processing on the first exception information by the second security monitoring module when the first exception information does not exceed a processing range of the second security monitoring module, or perform security processing on the first exception information by the first security monitoring module when the first exception information does not exceed the processing range of the first security monitoring module.

According to an embodiment of the present application, the first sending module 780 is configured to monitor a running state of the first level by the first security monitoring module.

According to an embodiment of the present application, the first sending module 780 is configured to monitor a running state of a function module included in the second level and a running state of the second security monitoring module by the first security monitoring module, where the first level includes a virtual machine monitor the second level includes a plurality of operating systems, and the third level includes an ECU security island core.

According to an embodiment of the present application, the collecting module 710 is configured to collect second exception information of a function module on an operating system by a diagnostic module of the second level; the second sending module 720 is configured to send the second exception information to the second security monitoring module by the diagnosis module; the dividing module 730 is configured to divide the second exception information into a corresponding security level by the second security monitoring module; the first security processing module 740 is configured to control the function module to restart according to the security level, or send the second exception information to a processing module corresponding to the security level for security processing according to the security level, by the second security monitoring module, where the processing module includes the function module; and the third sending module 750 is configured to take the second exception information as first exception information when the second exception information exceeds a processing range of the processing module, and send the first exception information to the first security monitoring module by the second security monitoring module.

It should be understood that specific working processes and functions of the collecting module 710, the second sending module 720, the dividing module 730, the first security processing module 740, the third sending module 750, the receiving module 760, the determining module 770, the first sending module 780, and the second security processing module 790 in the foregoing embodiments may refer to the descriptions in the method and system for security monitoring provided in the above embodiments of FIG. 1 to FIG. 6, and in order to avoid repetition, details are not described herein again.

Exemplary Electronic Device and Computer-Readable Storage Medium

FIG. 8 is a block diagram of an electronic device 800 for security monitoring according to an exemplary embodiment of the present application.

Referring to FIG. 8, the electronic device 800 includes a processing component 810 that further includes one or more processors, and memory resources represented by a memory 820 for storing instructions executable by the processing component 810, such as an application program. The application program stored in the memory 820 may include one or more modules each corresponding to a set of instructions. In addition, the processing component 810 is configured to execute an instruction to perform the foregoing method for security monitoring of a vehicle-mounted system.

The electronic device 800 may further include a power supply component configured to perform power management of the electronic device 800, a wired or wireless network interface configured to connect the electronic device 800 to a network, and an input/output (I/O) interface. The electronic device 800 may be operated on the basis of an operating system stored in the memory 820, such as Windows Server™, Mac OS X™, Unix™, Linux™, or FreeBSD™, or the like.

A non-transitory computer-readable storage medium is provided, and when instructions in a storage medium are executed by a processor of the electronic device 800, a method for security monitoring of a vehicle-mounted system may be performed by the electronic device 800. The vehicle-mounted system includes a plurality of levels of functions, and the method includes: receiving, by a first security monitoring module of a first level of a plurality of levels, first exception information sent by a second security monitoring module of a second level, where the first level is an upper level of the second level; determining, by the first security monitoring module, whether the first exception information exceeds a processing range of the first security monitoring module; and sending the first exception information to a third level by the first security monitoring module when the first exception information exceeds the processing range of the first security monitoring module, and performing security processing on the first exception information by the third level, where the third level is an upper level of the first level.

Exemplary Vehicle

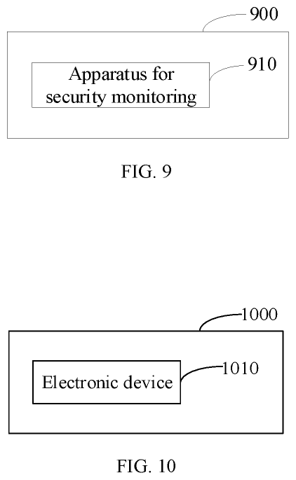

FIG. 9 is a block diagram of a vehicle 900 according to in exemplary embodiment of the present application.

Referring to FIG. 9, the vehicle 900 includes an apparatus 910 for security monitoring, and with regard to the specific description of the apparatus 910 for security monitoring, please refer to the disclosure in the embodiment of FIG. 7 for details.

FIG. 10 is a block diagram of a vehicle 1000 according to another exemplary embodiment of the present application.

Referring to FIG. 10, the vehicle 1000 includes an electronic device 1010, and with regard to the specific description of the electronic device 1010, please refer to the disclosure in the embodiment of FIG. 8 for details.

All optional technical solutions above may be randomly combined to form an optional embodiment of the present application, and details are not described herein again.

A person of ordinary skill in the art may be aware that, in combination with the examples described in the embodiments disclosed in this specification, units, and algorithm steps may be implemented by electronic hardware, computer software, or a combination thereof. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

It may be clearly understood by a person skilled in the art that, for the purpose of convenient and brief description, for a detailed working process of the foregoing system, apparatus, and unit, may be referred to a corresponding process in the foregoing method embodiments, and details are not described herein again.

In several embodiments provided in the present application, it should be understood that the disclosed system, apparatus, and method may be implemented in other manners. For example, the described device embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatus or units may be implemented in electronic, mechanical, or other forms.

The units described as separate parts may or may not be physically separated, and parts displayed as units may or may not be physical units, that is, may be located in one position, or may be distributed on a plurality of network units. A part or all of the units may be selected according to actual needs to achieve the objectives of the solutions of the embodiments of the present application.

In addition, each function unit in the embodiments of the present application may be integrated into one processing unit, or each of the units may exist alone physically, or two or more units are integrated into one unit.

When the functions are implemented in a form of a software function unit and sold or used as an independent product, the functions may be stored in a computer-readable storage medium. Based on such an understanding, the technical solutions of the present application essentially, or the part contributing to the prior art, or a part of the technical solutions may be implemented in a form of a software product. The computer software product is stored in a storage medium and includes several instructions for instructing a computer device (which may be a personal computer, a server, a network device, or the like) to perform all or a part of the steps of the methods described in the embodiments of the present application. The foregoing storage medium includes: any medium that may store program check codes, such as a USB flash disk, a mobile hard disk, a Read-Only Memory (ROM), a Random Access Memory (RAM), a magnetic disk, or an optical disk.

It should be noted that in the description of the present application, the terms “first” “second”, “third”, and the like are merely intended for a purpose of description, and shall not be understood as an indication or implication of relative importance. In addition, in the descriptions of the present application, unless otherwise stated, “a plurality of” means at least two.

The foregoing descriptions are merely preferred embodiments of the present application, and are not intended to limit the present application, and any modification, equivalent replacement, etc. made within the spirit and principles of the present application should be included within the protection scope of the present application.

1. A method for security monitoring of a vehicle-mounted system, wherein the vehicle-mounted system comprises a plurality of levels of functions, and the method comprises:
receiving, by a first security monitoring module of a first level of the plurality of levels, first exception information sent by a second security monitoring module of a second level, wherein the first level is an upper level of the second level;
determining, by the first security monitoring module, whether the first exception information exceeds a processing range of the first security monitoring module; and
sending, by the first security monitoring module, the first exception information to a third level when the first exception information exceeds the processing range of the first security monitoring module, and performing security processing on the first exception information by the third level, wherein the third level is an upper level of the first level.

2. The method for security monitoring according to claim 1, wherein the method further comprises:
performing security processing on the first exception information by the second security monitoring module when the first exception information does not exceed a processing range of the second security monitoring module; or
performing security processing on the first exception information by the first security monitoring module when the first exception information does not exceed the processing range of the first security monitoring module.

3. The method for security monitoring according to claim 1, wherein the method further comprises:
monitoring, by the first security monitoring module, a running state of the first level.

4. The method for security monitoring according to claim 1, wherein the method further comprises:
monitoring, by the first security monitoring module, a running state of a function module included in the second level, and a running state of the second security monitoring module,
wherein the first level comprises a virtual machine monitor, the second level comprises a plurality of operating systems, and the third level comprises an ECU security island core.

5. The method for security monitoring according to claim 4, wherein before the receiving, by a first security monitoring module of a first level of the plurality of levels, first exception information is sent by a second security monitoring module of a second level, the method further comprises:
collecting, by a diagnostic module of the second level, second exception information of a function module on an operating system;
sending, by the diagnostic module, the second exception information to the second security monitoring module;
dividing, by the second security monitoring module, the second exception information into a corresponding security level;
controlling the function module to restart according to the security level, or sending the second exception information to a processing module corresponding to the security level for security processing according to the security level, by the second security monitoring module, wherein the processing module comprises the function module; and
taking the second exception information as the first exception information when the second exception information exceeds a processing range of the processing module, and sending, by the second security monitoring module, the first exception information to the first security monitoring module.

6. (canceled)

7. An electronic device, comprising:
a processor; and
a memory configured to store instructions executable by the processor,
wherein the processor is configured to execute operations for security monitoring of a vehicle-mounted system, the operations comprising:
receiving, by a first security monitoring module of a first level of the plurality of levels, first exception information sent by a second security monitoring module of a second level, wherein the first level is an upper level of the second level;
determining, by the first security monitoring module, whether the first exception information exceeds a processing range of the first security monitoring module; and
sending, by the first security monitoring module, the first exception information to a third level when the first exception information exceeds the processing range of the first security monitoring module, and performing security processing on the first exception information by the third level, wherein the third level is an upper level of the first level.

8. (canceled)

9. A non-transitory computer-readable storage medium, encoded with instructions that, when executed by one or more computers, cause the one or more computers to perform operations for security monitoring of a vehicle-mounted system, the operations comprising:
receiving, by a first security monitoring module of a first level of the plurality of levels, first exception information sent by a second security monitoring module of a second level, wherein the first level is an upper level of the second level;
determining, by the first security monitoring module, whether the first exception information exceeds a processing range of the first security monitoring module; and
sending, by the first security monitoring module, the first exception information to a third level when the first exception information exceeds the processing range of the first security monitoring module, and performing security processing on the first exception information by the third level, wherein the third level is an upper level of the first level.

10. (canceled)

11. The non-transitory computer-readable storage medium according to claim 9, wherein the operations further comprise:
performing security processing on the first exception information by the second security monitoring module when the first exception information does not exceed a processing range of the second security monitoring module; or
performing security processing on the first exception information by the first security monitoring module when the first exception information does not exceed the processing range of the first security monitoring module.

12. The non-transitory computer-readable storage medium according to claim 9, wherein the operations further comprise:
monitoring, by the first security monitoring module, a running state of the first level.

13. The non-transitory computer-readable storage medium according to claim 9, wherein the operations further comprise:
monitoring, by the first security monitoring module, a running state of a function module included in the second level, and a running state of the second security monitoring module,
wherein the first level comprises a virtual machine monitor, the second level comprises a plurality of operating systems, and the third level comprises an ECU security island core.

14. The non-transitory computer-readable storage medium according to claim 13, wherein before the receiving, by a first security monitoring module of a first level of the plurality of levels, first exception information is sent by a second security monitoring module of a second level, the operations further comprise:
collecting, by a diagnostic module of the second level, second exception information of a function module on an operating system;
sending, by the diagnostic module, the second exception information to the second security monitoring module;
dividing, by the second security monitoring module, the second exception information into a corresponding security level;
controlling the function module to restart according to the security level, or sending the second exception information to a processing module corresponding to the security level for security processing according to the security level, by the second security monitoring module, wherein the processing module comprises the function module; and
taking the second exception information as the first exception information when the second exception information exceeds a processing range of the processing module, and sending, by the second security monitoring module, the first exception information to the first security monitoring module.

15. The electronic device according to claim 7, wherein the operations further comprise:
performing security processing on the first exception information by the second security monitoring module when the first exception information does not exceed a processing range of the second security monitoring module; or
performing security processing on the first exception information by the first security monitoring module when the first exception information does not exceed the processing range of the first security monitoring module.

16. The electronic device according to claim 7, wherein the operations further comprise:
monitoring, by the first security monitoring module, a running state of the first level.

17. The electronic device according to claim 7, wherein the operations further comprise:
monitoring, by the first security monitoring module, a running state of a function module included in the second level, and a running state of the second security monitoring module,
wherein the first level comprises a virtual machine monitor, the second level comprises a plurality of operating systems, and the third level comprises an ECU security island core.

18. The electronic device according to claim 17, wherein before the receiving, by a first security monitoring module of a first level of the plurality of levels, first exception information is sent by a second security monitoring module of a second level, the operations further comprise:
collecting, by a diagnostic module of the second level, second exception information of a function module on an operating system;
sending, by the diagnostic module, the second exception information to the second security monitoring module;
dividing, by the second security monitoring module, the second exception information into a corresponding security level;
controlling the function module to restart according to the security level, or sending the second exception information to a processing module corresponding to the security level for security processing according to the security level, by the second security monitoring module, wherein the processing module comprises the function module; and
taking the second exception information as the first exception information when the second exception information exceeds a processing range of the processing module, and sending, by the second security monitoring module, the first exception information to the first security monitoring module.

19. The electronic device according to claim 7, wherein the electronic device is located on a vehicle.
